(19) United States
(12) Patent Application Publication
(10) Pub. No.: US 2026/0010947 A1
(43) Pub. Date: Jan. 8, 2026

(54) METHOD OF OPERATING ONLINE FINANCIAL PRODUCT, WHICH RAPIDLY OPENS AND PROVIDES ROSCA-TYPE ONLINE FINANCIAL PRODUCT, AND FINANCIAL SERVICE SERVER FOR PERFORMING SAME

(71) Applicant: TWAVE CO., LTD., Busan (KR)

(72) Inventor: Jae Jun SEO, Seoul (KR)

(21) Appl. No.: 19/210,881

(22) Filed: May 16, 2025

Related U.S. Application Data
(63) Continuation of application No. PCT/KR2025/001822, filed on Feb. 7, 2025.

(30) Foreign Application Priority Data
Feb. 8, 2024 (KR) 10-2024-0019337

(51) Int. Cl. G06Q 40/03

(52) U.S. Cl. CPC G06Q 40/0305

(57) ABSTRACT

A method of operating an online financial product corresponding to transaction at an order of a participation entry included in a Rotating Savings and Credit Association (RoSCA)-type online financial product includes transmitting information of a target financial product including detailed information of a first participation entry to a first user terminal; receiving a first request message requesting partial participation in the first participation entry from the first user terminal; and allowing a first user corresponding to the first user terminal to participate as a first partial participant of the first participation entry on the basis of reception of the first request message. In this case, the target financial product includes a plurality of participation entries including the first participation entry. The method is performed in a financial service server.

### CROSS-REFERENCE TO RELATED APPLICATIONS

This application is a Continuation of International Application No. PCT/KR2025/001822 filed Feb. 7, 2025, which claims priority from Korean Application No. 10-2024-0019337 filed Feb. 8, 2024. The aforementioned applications are incorporated herein by reference in their entireties.

### TECHNICAL FIELD

The embodiments of the present disclosure relate to a method of operating an online financial product, which rapidly opens and provides a Rotating Savings and Credit Association (RoSCA)-type online financial product, and to a financial service server for performing the method.

### RELATED ART

Peer-to-Peer (P2P) finance is a credit loan service between a plurality of lenders and a plurality of borrowers through an open internet marketplace, and has been experiencing rapid growth worldwide. In Korea as well, as the number of low-credit individuals unable to obtain loans from traditional financial institutions increases, financially excluded individuals who cannot use traditional financial institutions can receive loan services through P2P finance.

In particular, a Rotating Savings and Credit Association (RoSCA)-type online financial product, which is similar to the Korean Gye system, is a collective savings system in which each member (i.e., participant) agrees to contribute a fixed amount (i.e., a contribution amount) regularly and takes turns receiving a lump sum (i.e., a payout amount or a substantial amount of money). The lump sum is used for various purposes, such as starting a business, paying tuition fees, and purchasing a house.

In detail, a RoSCA-type online financial product comprises a plurality of participation entries, and the RoSCA-type online financial product is opened and served only when a plurality of participants corresponding to the plurality of participation entries, respectively, are recruited. In this case, each of the plurality of participation entries has different detailed information (e.g., payout amount, agreed interest rate, order, and contribution amount).

Meanwhile, it may often happen that the detailed information of a specific participation entry among a plurality of participation entries does not meet some users' purposes for using the financial product (e.g., loans or investments). In this case, there is a problem in that due to the difficulty in recruiting participants for a specific participation entry, a RoSCA-type online financial product may be opened late or may fail to be opened.

### SUMMARY

The object of the present disclosure is to provide a method of operating an online financial product, which can rapidly open and serve a RoSCA-type online financial product, and a financial service server for performing the method.

Further, the object of the present disclosure is to provide a method of operating an online financial product, which can minimize financial risks arising from termination of a RoSCA-type online financial product, and a financial service server for performing the method.

Further, the object of the present disclosure is to provide a method of operating an online financial product, which ensures additional revenue to financial service provider companies, and a financial service server for performing the method.

The objects of the present disclosure are not limited to those described above and other objects and advantages of the present disclosure not stated above may be understood through the following description and may be more clearly understood by the embodiments of the present disclosure. Further, it will be easily known that the objects and advantages of the present disclosure may be achieved by the means described in the claims and a combination thereof.

A method of operating an online financial product according to an embodiment of the present disclosure is a method that is performed in a financial service server and operates a Rotating Savings and Credit Association (RoSCA)-type online financial product, and the method includes the steps of: transmitting information of a target financial product including detailed information of a first participation entry to a first user terminal, receiving a first request message requesting partial participation in the first participation entry from the first user terminal, and allowing a first user corresponding to the first user terminal to participate as a first partial participant of the first participation entry on the basis of reception of the first request message. In this case, the target financial product comprises a plurality of participation entries including the first participation entry.

A financial service server that operates a RoSCA-type online financial product according to an embodiment of the present disclosure includes a communication unit transmitting information of a target financial product including detailed information of a first participation entry to a first user terminal, and receiving a first request message requesting partial participation in the first participation entry from the first user terminal, and a processor unit allowing a first user corresponding to the first user terminal to participate as a first partial participant of the first participation entry on the basis of reception of the first request message. In this case, the target financial product comprises a plurality of participation entries including the first participation entry.

According to the present disclosure, it is possible to quickly open and serves a RoSCA-type online financial product.

Further, according to the present disclosure, it is possible to minimize financial risks arising from termination of a RoSCA-type online financial product.

Further, according to the present disclosure, it is possible to ensure additional revenue for financial service provider companies.

Further, the effects of the present disclosure are not limited to the above effects and it should be understood that the effects include all effects that can be inferred from the configuration of the present disclosure described in the detailed description or the claims of the present disclosure.

### BRIEF DESCRIPTION OF THE DRAWINGS

FIG. 1 is a diagram showing the schematic configuration of a system for operating an online financial service according to an embodiment of the present disclosure.

FIG. 2 is a diagram showing the schematic configuration of a financial service server according to an embodiment of the present disclosure.

FIG. 3 is a diagram illustrating the concept of a RoSCA-type online financial product according to an embodiment of the present disclosure.

FIG. 4 is a diagram illustrating the overall process flow of a method of operating a RoSCA-type financial product according to an embodiment of the present disclosure.

FIGS. 5A, 5B, and 5C are diagrams showing the concept of the method of FIG. 4.

FIG. 6 is a diagram showing the overall process flow of a method of operating a RoSCA-type financial product according to a second embodiment of the present disclosure.

FIGS. 7A, 7B, and 7C are diagrams illustrating the concept of the method of FIG. 6.

### DETAILED DESCRIPTION

The present disclosure may be modified in various ways and implemented by various exemplary embodiments, so that specific exemplary embodiments are shown in the drawings and will be described in detail. However, it is to be understood that the present disclosure is not limited to the specific exemplary embodiments, but includes all modifications, equivalents, and substitutions included in the spirit and the technical scope of the present disclosure. Similar reference numerals are assigned to similar components in describing each drawing.

Although the terms “first”, “second”, etc. may be used herein to describe various components, these components should not be limited by these terms. The above terms are used only to discriminate one component from another component. The term “and/or” includes a combination of a plurality of relevant items or any one of a plurality of relevant items.

It is to be understood that when an element is referred to as being “connected to” or “coupled to” another element, it may be directly connected to or directly coupled to another element or be connected to or coupled to another element with the other element therebetween. On the other hand, it is to be understood that when an element is referred to as being “directly connected to” or “directly coupled to” another element, it may be connected to or coupled to another element without the other element therebetween.

The terms used in the present specification are used only to describe specific exemplary embodiments rather than limiting the present disclosure. Singular forms include plural forms unless the context clearly indicates otherwise. It will be further understood that the terms “comprises” or “have” as used in this specification are intended to designate the presence of stated features, numbers, steps, operations, components, parts, or a combination thereof, but not to preclude the possibility of the presence or addition of one or more other features, numbers, steps, operations, components, parts, or a combination thereof.

Unless defined otherwise, all the terms used herein including technical or scientific terms have the same meanings as those that are generally understood by those having ordinary skill in the art to which the present invention pertains. The terms such as those defined in common dictionaries should be construed as having a meaning consistent with their meanings in the context of the relevant art, and should not be construed in an idealized or overly formal sense unless expressly so defined herein.

Hereinafter, exemplary embodiments of the present disclosure will be described in detail with reference to the accompanying drawings.

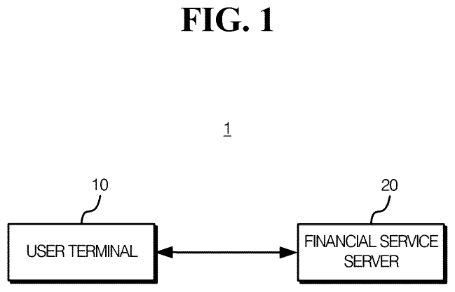

FIG. 1 is a diagram showing the schematic configuration of a system 1 for operating an online financial service according to an embodiment of the present disclosure.

Referring to FIG. 1, the system 1 for operating an online financial service may include a user terminal 10 and a financial service server 20.

The user terminal 10 may be a process-based device owned by a user. For example, the user terminal 10 may also be referred to as various names such as a mobile terminal, a wireless device, a wireless transmit/receive unit, or a mobile subscriber unit. For example, the user terminal 10 may be a smart phone, a tablet PC, or a laptop.

A client-side financial application for providing an online financial service may be installed on the user terminal 10. The client-side financial application can be executed by a processor unit of the user terminal 10.

The financial service server 20 is connected to the user terminal 10 for communication purposes, and a server-side financial application may be installed therein. The server-side financial application can serve various online financial products by interworking with the client-side financial application.

Meanwhile, as described below, the online financial product may be a Rotating Savings and Credit Association (RoSCA)-type online financial product. The RoSCA-type online financial product may include a plurality of participation entries in which a plurality of users participate. Accordingly, although not clearly shown in FIG. 1, there may be a plurality of user terminals 10. The RoSCA-type online financial product will be described in more detail below.

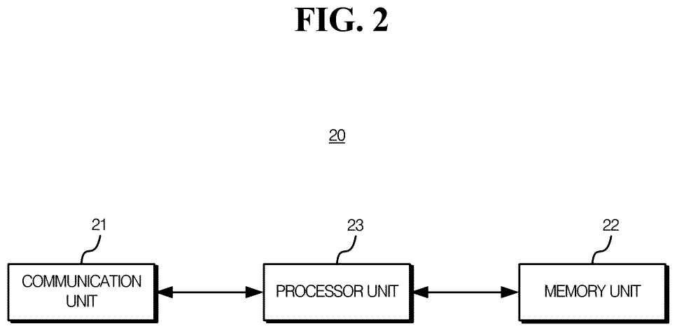

FIG. 2 is a diagram showing the schematic configuration of the financial service server 20 according to an embodiment of the present disclosure.

Referring to FIG. 2, the financial service server 20 may include a communication unit 21, a memory unit 22, and a processor unit 23.

The communication unit 21 can communicate with the user terminal 10. For example, the communication unit 21 may be a short-range communication module and/or a long-range communication module. The short-range communication module may be a communication module based on Bluetooth, Radio Frequency Identification (RFID), infrared Data Association (IrDA), Ultra-Wideband (UWB), ZigBee, or Wireless fidelity (WiFi). The long-range communication module may be a communication module based on code division multiple access (CDMA), frequency division multiple access (FDMA), time division multiple access (TDMA), orthogonal frequency division multiple access (OFDMA), or single carrier frequency division multiple access (SCFDMA).

The memory unit 22 may be volatile and/or a nonvolatile memory and can store instructions or data related to at least one other component of the financial service server 20. Particularly, the memory unit 22 can store instructions or data related to a computer program, an application, a recording medium, etc. operated in the financial service server 20. Particularly, the computer program/application may be for serving online financial products.

The processor unit 23 may include one or more of a central processing unit, an application processor, or a communication processor. The processor unit 13 can perform calculation or data processing about control and/or communication of at least one other components of the management server 10. Particularly, the processor unit 23 can execute the instructions of the computer program/application.

Although not shown in FIG. 2, the financial service server may further include a display unit, a storage unit, etc.

Hereafter, a RoSCA-type online financial product that is provided by the financial service server 20 is described in detail.

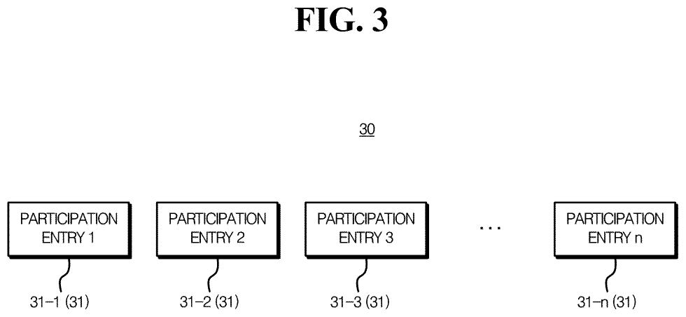

FIG. 3 is a diagram for explaining the concept of a RoSCA-type online financial product 30 according to an embodiment of the present disclosure.

Hereafter, for the convenience of description, the RoSCA-type online financial product is referred to as a “RoSCA financial product 30”.

Referring to FIG. 3, the RoSCA financial product 30 may include a plurality of, that is, N (an integer of 2 or more) participation entries 31. In this case, the RoSCA financial product 30 may be referred to as a “stage” and the N participation entries 31 may be referred to as “N stage participation spaces”.

The RoSCA financial product 30 may be created by a specific user, that is, a creating user, and N participating users, including the creating user, can participate in the N participation entries 31.

The N participation entries 31 can be assigned with sequential orders. In accordance with the order assigned to each of the N participation entries 31, at least one of a payout amount (i.e., a lump sum, a disbursement amount, or a maturity amount), an agreed interest rate, and a contribution amount (e.g., monthly contribution amount) may be set for each participation entry 31.

In detail, a RoSCA financial product 30 that has N participation entries 31 with sequential orders and in which a total of N contribution amounts are paid and one maturity amount is disbursed may be created. Each participating user is required to pay a total of N contribution amounts and can receive one maturity amount, and the timing of maturity amount disbursement may be determined on the basis of the orders of the participation entries 31. For the convenience of description, it is assumed that the number of the participation entries 31 and the number of payment rounds of the contribution amount are the same. However, the present disclosure is not limited thereto, and the number of the participation entries 31 and the number of payment rounds of the contribution amount may be different.

The contribution amounts of each participating user (i.e., the first to nth contribution amounts) may be set to be different from each other in accordance with the orders of the corresponding participation entries 31, and the maturity amounts of each participating user may be set to be the same regardless of the orders of the participation entries 31. Alternatively, the contribution amounts of each participating user may be set to be the same regardless of the orders of the participation entries 31, and the maturity amounts of each participating user may be set to be different from each other in accordance with the orders of the corresponding participation entries 31. Further, the participating user who joined the nth (n is an integer from 1 to N) participation entry 31 of the N participation entries 31 can receive the maturity amount in the nth payment round.

Each participating user can select the order of the participation entries 31 in accordance with the purpose of using the RoSCA financial product 30.

In detail, a user who urgently needs a substantial amount of money can participate in a participation entry 31 with an earlier order among the N participation entries 31. In this case, the agreed interest rate of a participation entry 31 with an earlier order may be a negative agreed interest rate, and the user can receive the maturity amount earlier, but there is a drawback that the maturity amount becomes smaller than the total contribution amounts. As another example, a user who seeks financial income (e.g., interest) can participate in a participation entry 31 with a later order among the N participation entries 31. This case has the advantage that the agreed interest rate for a participation entry 31 with a later order may be a positive agreed interest rate, and the user benefits from receiving a maturity amount greater than the total payment, but has the drawback that the maturity amount is received later.

In other words, a user participating in a participation entry 31 with a relatively earlier order can use the RoSCA financial product 30 for loan purposes, whereas a user participating in a participation entry 31 with a relatively later order can use the RoSCA financial product 30 for investment purposes. For example, when five participation entries 31 exist, participating users of participation entries 31 with orders 1 and 2 can use the RoSCA financial product 30 for loan purposes, whereas participating users of participation entries 31 with orders 4 and 5 can use the RoSCA financial product 30 for investment purposes.

Hereafter, the operation of the financial service server 20 operating a RoSCA-type online financial product is described based on the description of FIG. 3.

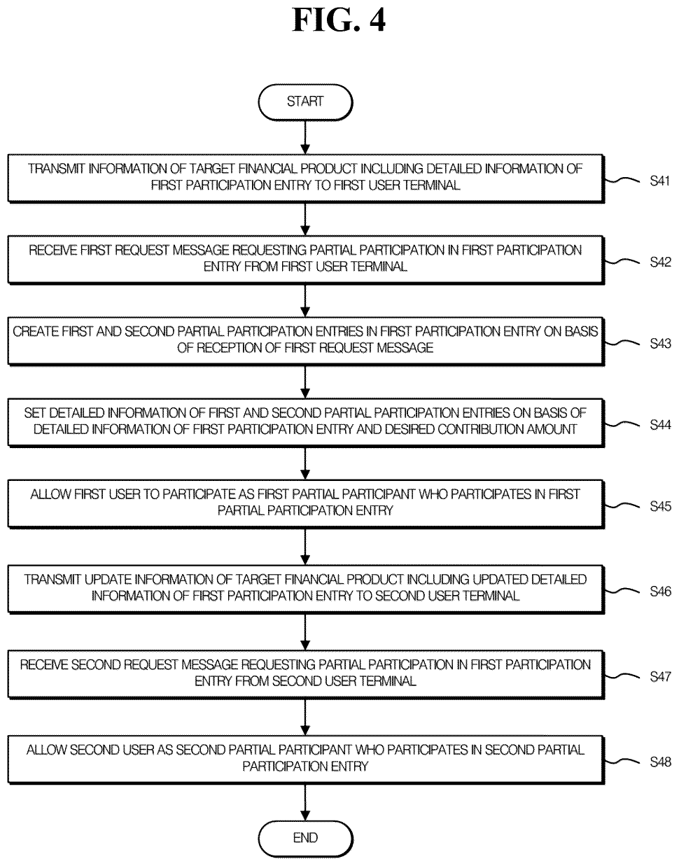

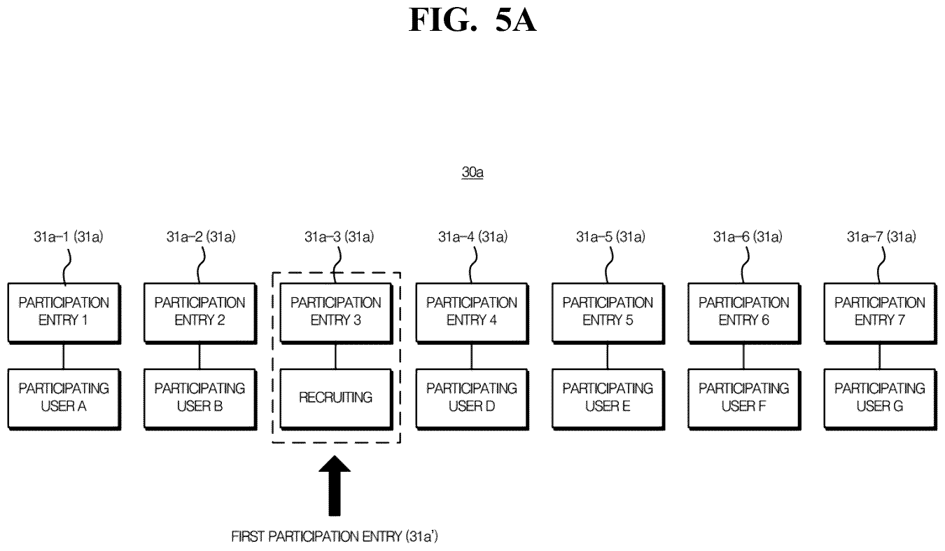

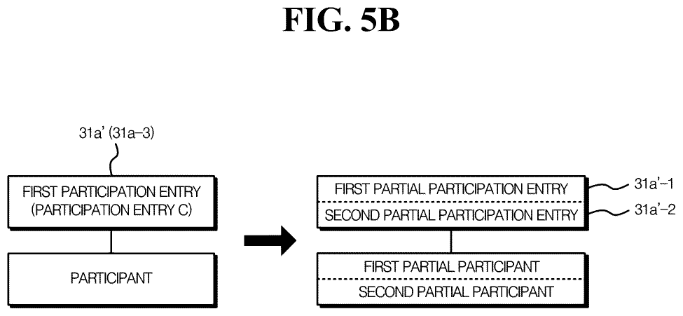

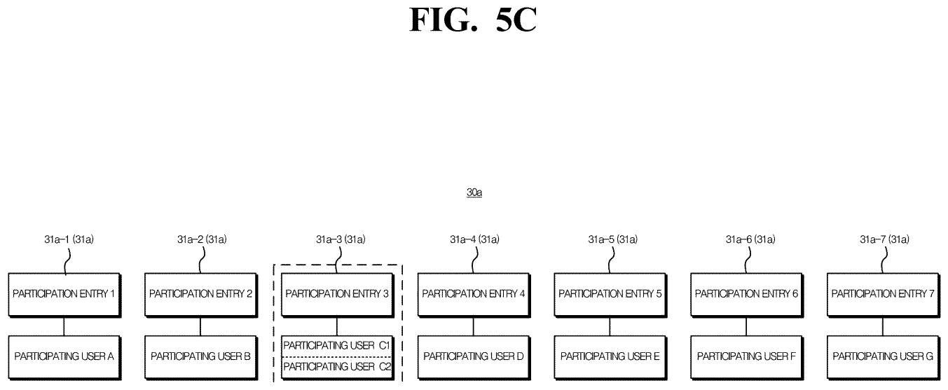

FIG. 4 is a diagram illustrating the overall process flow of a method of operating a RoSCA-type financial product according to a first embodiment of the present disclosure, and FIGS. 5A, 5B, and 5C are diagrams illustrating the concept of the method of FIG. 4.

The method of operating a RoSCA-type financial product can be served through interworking of a server-side financial application that is executed in the financial service server 20 and a client-side financial application that is executed in the user terminal 10. Further, it is assumed that a target financial product 30a of the RoSCA type has been previously created and has not been opened yet. In this case, “open” may correspond to a state in which the target financial product 30a is being served after a plurality of participants have been recruited for a plurality of participation entries, respectively.

Hereafter, the process of the steps in FIG. 4, which constitute the method of operating a RoSCA financial product, is described in detail on the basis of the financial service server 20.

In step S41, the financial service server 20 can transmit the information of the target financial product 30a, including the detailed information of a first participation entry 31a′, to a first user terminal 10.

In this case, among the plurality of participation entries 31a constituting the target financial product 30a, the first participating entry 31a′ may be a participation entry for which no participant has been recruited, and the first user corresponding to the first user terminal 10 may be a user who seeks to receive the service of the target financial product 30a.

Referring to FIG. 5A, the target financial product 30a may include seven participation entries 31a, and among them, a participation entry 3 (31a-3) is currently recruiting participants. Accordingly, the participation entry 3 (31a-3) may be the first participation entry 31a′.

Meanwhile, the financial service server 20 can provide the first user terminal 10 with a User Interface (UI) including the information of a plurality of financial products that is currently recruiting participants, and the first user can be provided with the information of the target financial product 30a from the financial service server 20 by selecting the target financial product 30a of the plurality of financial products.

According to an embodiment, the detailed information of the first participation entry 31a′ may include the payout amount, the agreed interest rate, the order, and the contribution amount of the first participation entry 31a′. The payout amount, the agreed interest rate, the order, and the contribution amount were described above.

In step S42, the financial service server 20 can receive a first request message requesting partial participation in the first participation entry 31a′ from the first user terminal 10.

That is, a plurality of participants can partially participate in one participation entry 31a, and each of the plurality of participants can be called “partial participant”. The first request message may be a message requesting the first user to participate in the first participation entry 31a′ as a partial participant.

According to an embodiment, the first request message may include the information of the desired contribution amount of the first user. For example, the desired contribution amount may be a monthly contribution amount that the target user pays per round.

In step S43, the financial service server 20 can create first and second partial participation entries 31a′-1 and 31a′-2 in the first participation entry 31a′ on the basis of reception of the first requesting message.

Referring to FIG. 5B, a first partial participant may participate in the first partial participation entry 31a′-1, and a second partial participant may participate in the second partial participation entry 31a′-2. The first and second partial participants can be participants of the first participation entry 31a′.

In step S44, the financial service server 20 can set the detailed information of the first and second partial participation entries 31a′-1 and 31a′-2 on the basis of the detailed information of the first participation entry 31a′ and the desired contribution amount.

In this case, similar to the detailed information of the first participation entry 31a′, the detailed information of the first and second partial participation entries 31a′-1 and 31a′-2 may include a payout amount, a agreed interest rate, an order, and a contribution amount.

According to an embodiment, the financial service server 20 can set the detailed information of the first partial participation entry 31a′-1 on the basis of the detailed information of the first participation entry 31a′ and the desired contribution amount. In detail, the financial service server 20 i) can set the agreed interest rate and the order of the first participation entry 31a′ as the agreed interest rate and the order of the first partial participation entry 31a′-1, ii) can set a desired contribution amount as the contribution amount of the first partial participation entry 31a′-1, and iii) can set the payout amount of the first partial participation entry 31a′-1 on the basis of the payout amount and the contribution amount of the first participation entry 31a′ and the desired contribution amount.

As an example, the first participation entry 31a′ of the target financial product 30a of FIG. 5A may have a payout amount of “7 million KRW”, an agreed interest rate of “−2.78%”, an order of “3”, and a contribution amount of “1.05 million KRW”. In this case, assuming that the desired contribution amount is “600,000 KRW”, the financial service server 20 can i) set the agreed interest rate and the order of the first partial participation entry 31a′-1 to be the same as the agreed interest rate and the order of the first participation entry 31a′, i.e., “−2.78%” and “order 3”, ii) can set the contribution amount of the first partial participation entry 31a′-1 to be the same as a desired contribution amount, i.e., “600,000 KRW”, and iii) can set the payout amount of the first partial participation entry 31a′-1 to “4 million KRW,” which is the value obtained by multiplying the desired contribution amount by the payout amount of the first participation entry 31a′ and dividing the result by the contribution amount of the first participation entry 31a′.

Further, according to an embodiment, the financial service server 20 can set the detailed information of the second partial participation entry 31a′-2 on the basis of the detailed information of the first participation entry 31a′ and the detailed information of the first partial participation entry 31a′-1. In detail, the financial service server 20 i) can set the agreed interest rate and the order of the first participation entry 31a′ as the agreed interest rate and the order of the second partial participation entry 31a′-2, and ii) can set the payout amount and the contribution amount of the second partial participation entry 31a′-2 on the basis of the payout amount and the contribution amount of the first partial participation entry 31a′-1.

As an example, in the example of FIG. 5A described above, the financial service server 20 i) can set the agreed interest rate and the order of the second partial participation entry 31a′-2 to be the same as the agreed interest rate and the order of the first partial participation entry 31a′, i.e., “−2.78%” and “order 3”, ii) can set the contribution amount of the second partial participation entry 31a′-2 to “450,000 KRW” that is “the value obtained by subtracting the contribution amount of the first partial participation entry 31a′-1 from the contribution amount of the first participation entry 31a′”, and iii) can set the payout amount of the second partial participation entry 31a′-2 to “3 million KRW” that is “the value obtained by subtracting the payout amount of the first partial participation entry 31a′-1 from the payout amount of the first participation entry 31a′”.

In step S45, the financial service server 20 can allow the first user to participate as a first partial participant who participates in the first partial participation entry 31a′-1. Meanwhile, although not shown in FIG. 4, the financial service server 20 can transmit information indicating that “the first user has participated in the first partial participation entry 30a′-1” to the first user terminal 10. Accordingly, partial participation of the first user in the first participation entry 31a′ is completed.

In step S46, the financial service server 20 can transmit updated information of the target financial product 30a, including the updated detailed information of the first participation entry 31a′, to a second user terminal 10.

In this case, the updated detailed information of the first participation entry 31a′ may include the detailed information of the first and second partial participation entries 31a′-1 and 31a′-2.

In step S47, the financial service server 20 can receive a second request message requesting partial participation in the first participation entry 31a′ from the second user terminal 10.

That is, the second user can check the detailed information of the first and second partial participation entries 31a′-1 and 31a′-2 through the second user terminal 20, and accordingly, the second user can transmit the second request message through the second user terminal 20. The second request message may include information indicating that the second user wishes to participate in the second partial participation entry 31a′-2.

In step S48, the financial service server 20 can allow the second user to participate as a second partial participant who participates in the second partial participation entry 31a′-2. Meanwhile, although not shown in FIG. 4, the financial service server 20 can transmit information indicating that “the second user has participated in the second partial participation entry 31a′-2” to the second user terminal 10. Accordingly, partial participation of the second user in the second participation entry 31a′ is completed.

FIG. 5C shows the target financial product 30a in which the first and second users have participated in the participation entry 3 (31a-3) as participating users C1 and C2. Since the participating users C1 and C2 partially participate in the participation entry 3 (31a-3), the opening of the target financial product 30a can be completed and the target financial product 30a can be served.

Meanwhile, although it was described with reference to FIG. 4 that two partial participation entries 31a′-1 and 31a′-2 are created in the first participation entry 31a′, the present disclosure is not limited thereto. According to another embodiment, three or more partial participation entries may be created in the first participation entry 31a′, and accordingly, a plurality of users can partially participate in the first participation entry 31a′ as partial participants. As an example, when a third user participates in the first participation entry 31a′ together with the first and second users, the agreed interest rate and the order in the detailed information of the third partial participation entry can be set to be the same as the agreed interest rate and the order of the first participation entry 31a′, and the payout amount and the contribution amount in the detailed information of the third partial participation entry can be set on the basis of the payout amounts and the contribution amounts of the first and second third partial participation entries.

In summary, some users may be unable to participate in the target financial product 30a as participants because the contribution amount of a specific participation entry 31a′ is burdensome, which may result in a situation where the target financial product 30a is not opened. However, according to the method of operating a financial product shown in FIG. 4, a plurality of users can partially participate in a specific participation entry 31a′, and the contribution amount of the specific participation entry 31a′ can be shared and paid by a plurality of users. Accordingly, participants for a specific participation entry 31a′ can be recruited quickly and efficiently, and as a result, it is possible to quickly open and serve the RoSCA-type online financial product. Further, even if one of a plurality of users fails to pay an contribution amount, the remaining users continue to pay the contribution amount, so it is possible to minimize financial risks arising from termination of the RoSCA-type online financial product.

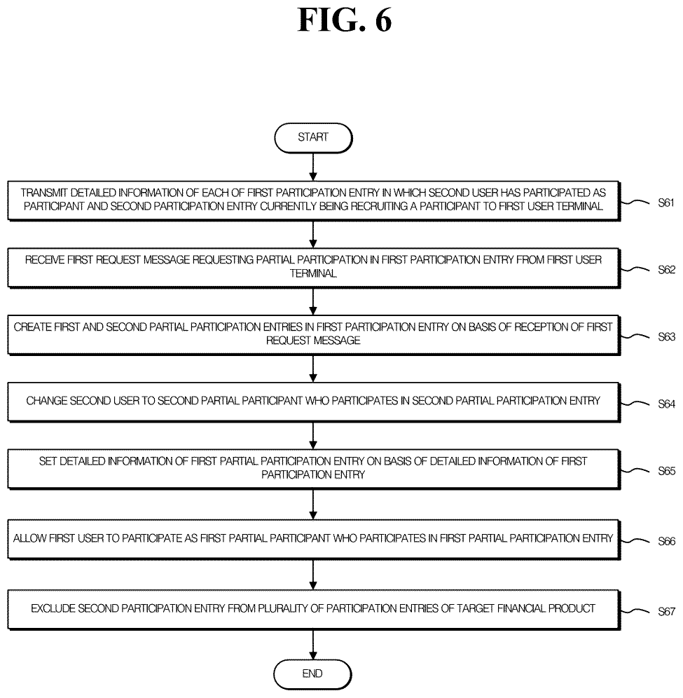

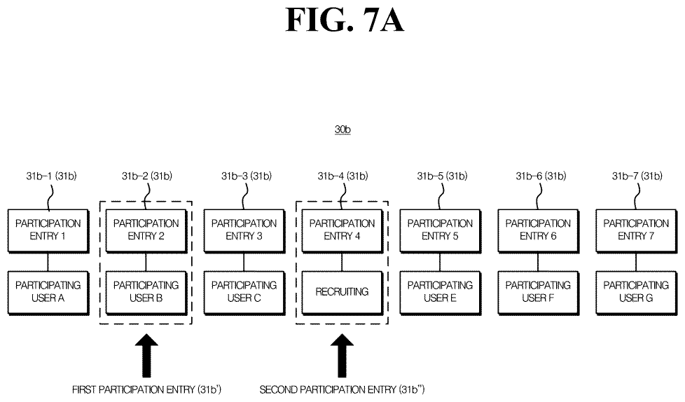

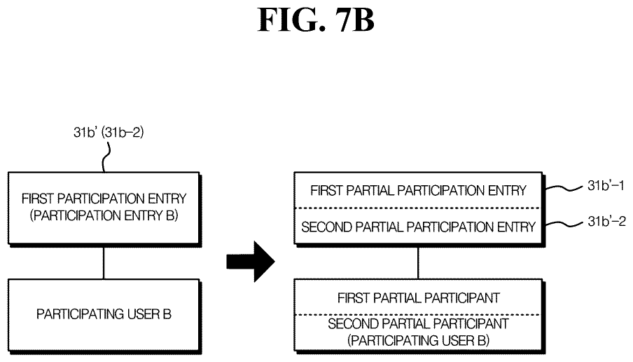

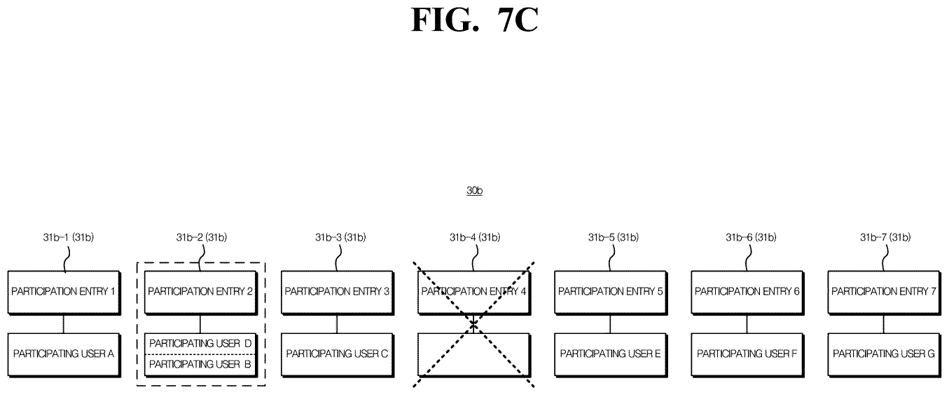

FIG. 6 is a diagram illustrating the overall process flow of a method of operating a RoSCA-type financial product according to a second embodiment of the present disclosure, and FIGS. 7A, 7B, and 7C are diagrams illustrating the concept of the method of FIG. 6.

The method of operating a RoSCA-type financial product can be served through interworking of a server-side financial application that is executed in the financial service server 20 and a client-side financial application that is executed in the user terminal 10. Further, it is assumed that a target financial product 30b of the RoSCA type has been previously created and has not been opened yet.

Hereinafter, the process of the steps in FIG. 6, which constitute the method of operating a ROSCA financial product, is described in detail on the basis of the financial service server 20.

In step S61, the financial service server 20 can transmit the information of a target financial product 30b, which includes the detailed information of a first participation entry 31b′ in which a second user has participated in as a participant, and the detailed information of a second participation entry 31b″, which is currently recruiting participants, to the first user terminal 10.

That is, a plurality of participation entries 31b constituting the target financial product 30b may include the first participation entry 31b′ in which the second user has participated as a participant and the second participation entry 31b″ that is currently recruiting participants. In this case, the order of the second participation entry 31b″ may be later than the order of the first participation entry 31b′.

Referring to FIG. 7A, the target financial product 30b may include seven participation entries 31b, and among them, a participating user B has participated in a participation entry 2 (31b-2), and a participation entry 4 (31b-4) is currently recruiting participants. In this case, the order of the participation entry 4 (31b-4) is later than the order of the participation entry 2 (31b-2). Accordingly, the participation entry 2 (31b-2) is a first participation entry 31b′ and the participation entry 4 (31b-4) is a second participation entry 31b″.

Meanwhile, the financial service server 20 can provide the first user terminal 10 with a UI including the information of a plurality of financial products that are currently recruiting participants, and the first user can be provided with the information of the target financial product 30b from the financial service server 20 by selecting the target financial product 30b of the plurality of financial products.

In step S62, the financial service server 20 can receive a first request message requesting partial participation in the first participation entry 31b′ from the first user terminal 10.

According to an embodiment, the first request message may include information indicating that the first user wishes to participate in the first participation entry 31b′ instead of the second participation entry 31b″.

That is, referring to FIG. 7A, the first participation entry 31b′ (i.e., the participation entry 2 (31b-2)) of the target financial product 30b may have a payout amount of “7 million KRW”, an agreed interest rate of “−4.24%”, an order of “order 2”, and a contribution amount of “1.08 million KRW”, and the second participation entry 31b″ (i.e., participation entry 4 (31b-4)) may have a payout amount of “7 million KRW”, an agreed interest rate of “0%”, an order of “order 4”, and a contribution amount of “1 million KRW”. In this case, the first user typically participates in the second participation entry 31b″ that is currently recruiting participants, but a situation may occur in which the first user wishes to participate in the first participation entry 31b′ in order to receive the payout amount faster than the second participation entry 31b″. Accordingly, the first user can transmit a first request message requesting partial participation in the first participation entry 31b′ to the financial service server 20 through the first user terminal 10.

In step S63, the financial service server 20 can create first and second partial participation entries 31b′-1 and 31b′-2 in the first participation entry 31b′ on the basis of reception of the first requesting message.

Referring to FIG. 7B, a first partial participant may participate in the first partial participation entry 31b′-1, and a second partial participant may participate in the second partial participation entry 31b′-2. The first and second partial participants can be participants of the first participation entry 31b′.

In step S64, the financial service server 20 can change the second user to a second partial participant who participates in the second partial participation entry 31b′-2.

That is, the financial service server 20 can change the second user participating in the first participation entry 31b′ to a second partial participant of the second partial participation entry 31b′-2. In this case, the detailed information (i.e., the payout amount, the agreed interest rate, the order, and the contribution amount) of the second partial participation entry 31b′-2 may be set to be the same as the detailed information of the first participation entry 31b′. This is shown in FIG. 7B.

In step S65, the financial service server 20 can set the detailed information of the first partial participation entry 31b′-1 on the basis of the detailed information of the first participation entry 31b′.

According to an embodiment, when all of the payout amounts of a plurality of participation entries 31b of the target financial product 30b are the same, the financial service server 20 i) can set the payout amount and the order of the first participation entry 31b′ to the payout amount and the order of the first partial participation entry 31b′-1, ii) can set the agreed interest rate of the first partial participation entry 31b′-1 to be less than the agreed interest rate of the first participation entry 31b′, and iii) can set the contribution amount of the first partial participation entry 31b′-1 on the basis of the payout amount and the agreed interest rate of the first partial participation entry 31b′-1.

According to another embodiment, when all of the contribution amounts of a plurality of participation entries 31b of the target financial product 30b are the same, the financial service server 20 i) can set the contribution amount and the order of the first participation entry 31b′ to the contribution amount and the order of the first partial participation entry 31b′-1, ii) can set the agreed interest rate of the first partial participation entry 31b′-1 to be less than the agreed interest rate of the first participation entry 31b′, and iii) can set the payout amount of the first partial participation entry 31b′-1 on the basis of the contribution amount and the agreed interest rate of the first partial participation entry 31b′-1.

In particular, when an immediately preceding participation entry of the first participation entry 31b′ exists, the financial service server 20 can set the agreed interest rate of the first partial participation entry 31b′-1 to be greater than the agreed interest rate of the immediately preceding participation entry and less than the agreed interest rate of the first participation entry 31b′.

As an example, in the example of FIG. 7A described above, a participation entry 1 (31b-1), which is the immediately preceding participation entry of the first participation entry 31b′ (i.e., a participation entry 2 (31b-2)), may exist, and the agreed interest rate of the participation entry 1 (31b-1) may be set to “−5.86%”. As described above, the first participation entry 31b′ may have a payout amount of “7 million KRW”, an agreed interest rate of “−4.24%”, an order of “order 2”, and a contribution amount of “1.08 million KRW”.

In this case, assuming that all of the contribution amounts of the plurality of participation entries 31b of the target financial product 30b are the same, the financial service server 20 i) can set the payout amount and the order of the first partial participation entry 31b′-1 to a payout amount of “7 million KRW” and an order of “order 2” that are the same as the payout amount and the order of the first participation entry 31a′, ii) can set the agreed interest rate of the first partial participation entry 31b′-1 to an agreed interest rate (e.g., −5.0%) between the agreed interest rate (−5.86%) of the immediately preceding participation entry and the agreed interest rate (−4.24%) of the first participation entry 31b′, and iii) can set the contribution amount of the first partial participation entry 31b′-1 to “1.10 million KRW” on the basis of the payout amount and the agreed interest rate of the first partial participation entry 31b′-1.

In step S66, the financial service server 20 can allow the first user to participate as a first partial participant who participates in the first partial participation entry 31b′-1.

That is, on the basis of step S64 and step S66, the participants of the first participation entry 31b′ can be composed of first and second partial participants, in which the first partial participant may be the first user who transmitted the first request message, and the second partial participant may be the second user who has previously participated in the first participation entry 31b′.

In step S67, the financial service server 20 can exclude the second participation entry 31b″ from the plurality of participation entries 31b of the target financial product 30b.

FIG. 7C shows an example of the target financial product 30b that is opened with the second participation entry 31b″ excluded.

Referring to FIG. 7C, participating users A, B, C, D, E, F, and G who are seven participating users can participate in seven participation entries 31b of the target financial product 30b. In this case, the participating users A, C, E, F, and G can receive the payout amount in the 1st, 3rd, 5th, 6th, and 7th rounds, respectively, the participating users B and D can receive the payout amount in the 2nd round, and there is no participating user who receives the payout amount in the 4th round.

In summary, the method of operating a financial product according to FIG. 6 can allow the first user to additionally participate in the first participation entry 31b′ in which the second user has previously participated. Accordingly, participants for a specific participation entry 31b′ can be recruited quickly and efficiently, and as a result, it is possible to quickly open and serve the RoSCA-type online financial product. Further, the financial service provider company can gain additional revenue by imposing a lower agreed interest rate on the first user participating in the first participation entry 31b′ compared to the agreed interest rate of the first participation entry 31b′.

Further, the embodiments of the present disclosure may be implemented in the form of program commands that can be executed by means of various computers and recorded on computer-readable media. The computer-readable media may include program commands, data files, and data structures individually or in combinations thereof. The program commands recorded on the media may be those specially designed and configured for the present invention or may also be those known and available to those engaged in computer software in the art. The computer-readable recording media include magnetic media such as hard disks, floppy disks, and magnetic tape; optical media such as CD-ROMs and DVDs; magneto-optical media such as floptical disks; and hardware devices specially configured to store and execute program commands, such as ROM, RAM, and flash memory. The program commands include not only machine language codes compiled by a compiler, but also high-level language code that can be executed by a computer using an interpreter etc. The hardware device may be configured to operate as one or more software modules to perform the operation of embodiments of the present disclosure, and vice versa.

Hereinabove, although the present disclosure is described by specific matters such as concrete components, and the like, limited embodiments, and drawings, they are provided only for assisting in the entire understanding of the present disclosure. Therefore, the present disclosure is not limited to the embodiments, and various modifications and variations can be made by those skilled in the art to which the present disclosure pertains from this description. Therefore, the spirit of the present disclosure should not be limited to the above-described embodiments, and the following claims as well as all things modified equally or equivalently to the claims will be considered to fall within the scope of the present disclosure.

What is claimed is:

1. A method that is performed in a financial service server and operates a Rotating Savings and Credit Association (RoSCA)-type online financial product, the method comprising:
transmitting information of a target financial product including detailed information of a first participation entry to a first user terminal, wherein the target financial product comprises a plurality of participation entries including the first participation entry;
receiving a first request message requesting partial participation in the first participation entry from the first user terminal; and
allowing a first user corresponding to the first user terminal to participate as a first partial participant of the first participation entry on the basis of reception of the first request message.

2. The method of claim 1, further comprising:
after the receiving of the first request message, creating first and second partial participation entries in the first participation entry; and
setting detailed information of the first and second partial participation entries on the basis of the detailed information of the first participation entry,
wherein the allowing the first user to participate as a first partial participant allows the first user to participate as the first partial participant who participates in the first partial participation entry, and
wherein the detailed information includes a payout amount, an agreed interest rate, an order, and a contribution amount.

3. The method of claim 2, wherein the first participation entry is a participation entry for which no participant has been recruited among the plurality of participation entries,
wherein the first request message includes information of a desired contribution amount of the first user, and
wherein the setting of the detailed information:
sets an agreed interest rate and an order of the first participation entry to an agreed interest rate and an order of the first partial participation entry;
sets the desired contribution amount to a contribution amount of the first partial participation entry; and
sets a payout amount of the first partial participation entry on the basis of a payout amount and a contribution amount of the first participation entry and the desired contribution amount.

4. The method of claim 3, wherein the setting of detailed information:
sets the agreed interest rate and the order of the first participation entry to an agreed interest rate and an order of the second partial participation entry; and
sets a payout amount and a contribution amount of the second partial participation entry on the basis of the payout amount and the contribution amount of the first participation entry and the payout amount and the contribution amount of the first partial participation entry.

5. The method of claim 4, further comprising:
after the allowing the first user to participate as a first partial participant, transmitting updated information of the target financial product, which includes updated detailed information of the first participation entry, to a second user terminal;
receiving a second request message requesting partial participation in the first participation entry from the second user terminal; and
allowing a second user corresponding to the second user terminal to participate as a second partial participant of the second partial participation entry of the first participation entry,
wherein the updated detailed information of the first participation entry includes the detailed information of the first and second partial participation entries.

6. The method of claim 2, wherein the plurality of participation entry includes the first participation entry in which a second user has participated as a participant, and a second participation entry for which no participant has been recruited and having an order later than an order of the first participation entry,
wherein the information of the target financial product further includes detailed information of the second participation entry, and
wherein the first request message includes information indicating that the first user wishes to participate in the first participation entry instead of the second participation entry.

7. The method of claim 6, wherein the setting of detailed information:
sets an agreed interest rate of the first partial participation entry to be less than an agreed interest rate of the first participation entry;
sets a payout amount and an order of the first participation entry to a payout amount and an order of the first partial participation entry and sets a contribution amount of the first partial participation entry on the basis of the payout amount and the agreed interest rate of the first partial participation entry, when payout amounts of the plurality of participation entries are the same; and
sets a contribution amount and an order of the first participation entry to the contribution amount and the order of the first partial participation entry and sets the payout amount of the first partial participation entry on the basis of the contribution amount and the agreed interest rate of the first partial participation entry, when contribution amounts of the plurality of participation entries are the same.

8. The method of claim 7, wherein when an immediately preceding participation entry of the first participation entry exists, the setting of detailed information sets the agreed interest rate of the first partial participation entry to be greater than an agreed interest rate of the immediately preceding participation entry.

9. The method of claim 6, wherein the setting of detailed information sets a payout amount, an agreed interest rate, an order, and a contribution amount of the first participation entry to a payout amount, an agreed interest rate, an order, and a contribution amount of the second partial participation entry, and
wherein the second user participates in the second partial participation entry, and the target financial product is opened without a participant recruited for the second participation entry.

10. A non-transitory computer-readable recording medium on which programs for executing the method of claim 1 in a computer are recorded.

11. A financial service server operating a Rotating Savings and Credit Association (RoSCA)-type online financial product, the financial service server comprising:
a communication unit transmitting information of a target financial product including detailed information of a first participation entry to a first user terminal, and receiving a first request message requesting partial participation in the first participation entry from the first user terminal, wherein the target financial product comprises a plurality of participation entries including the first participation entry; and
a processor unit allowing a first user corresponding to the first user terminal to participate as a first partial participant of the first participation entry on the basis of reception of the first request message.
